(19) United States
(12) Patent Application Publication
(10) Pub. No.: US 2018/0099403 A1
(43) Pub. Date: Apr. 12, 2018

(54) RAIL SYSTEM FOR SAWHORSES

(71) Applicant: Creative Plastic Concepts, LLC, Sycamore, OH (US)

(72) Inventor: Nickolas Reinhart, Findlay, OH (US)

(21) Appl. No.: 15/728,742

(22) Filed: Oct. 10, 2017

Related U.S. Application Data
(60) Provisional application No. 62/406,023, filed on Oct. 10, 2016.

(51) Int. Cl. B25H 1/04; B25H 1/00

(52) U.S. Cl. CPC B25H 1/04; B25H 1/0042

(57) ABSTRACT

A sawhorse rail system includes a plurality of sawhorses having a pair of recesses configured to fit a pair of rails. Each of the pair of rails has a T-shaped protrusion and T-shaped aperture, the T-shaped protrusion of one rail configured to fit in the T-shaped aperture of the other rail. The T-shaped protrusion and T-shaped aperture may further have a recess to accommodate a dog bone shaped connector. The pair of rails also connect with moveable positioners that secure a body forming a work surface.

### CROSS-REFERENCE TO RELATED APPLICATIONS

This application claims the benefit of U.S. Provisional Application No. 62/406,023, filed on Oct. 10, 2016. The entire disclosure of the above application is hereby incorporated herein by reference.

### FIELD

The disclosure generally relates to sawhorses and, in particular, to a rail system for sawhorses.

### BACKGROUND

Sawhorses are commonly used by carpenters, construction workers, mechanics, or homeowners for woodworking, new construction, remodeling, maintenance, or the like due to portability. The sawhorses typically include a platform for supporting a workpiece and two pairs of legs supporting the platform.

Typically, in order to accommodate a variety of applications, it may be required to manipulate a workpiece, such as a piece of wood, pipe, metal, drywall, plastic, or the like, by cutting or drilling the workpiece. Commonly, wooden boards and sheets may be laid across sawhorses to provide a work surface the workpiece. However, such work surfaces are very simple and are often not optimized to hold or secure particular workpieces.

Also, in certain scenarios, a table tool or power tool provides the most efficient means of manipulating the workpiece. Often, a workbench specified for the type of tool or workpiece may be required to manipulate the workpiece efficiently and accurately. However, those types of workbenches can be unwieldy, difficult to transport, unstable, or inflexible for multiple applications or purposes.

There is a continuing need for a rail system for sawhorses that provides a wieldy, portable, stable, and versatile workbench configured for manipulating workpieces for varying applications efficiently and accurately.

### SUMMARY

In concordance with the instant disclosure, a rail system for sawhorses that provides a wieldy, portable, stable, and versatile workbench configured for manipulating workpieces efficiently and accurately has surprisingly been discovered.

In one embodiment, a pair of rails releasably extend between a plurality of adjacent sawhorses to form a workbench. Each rail has a track that is configured to connect with a moveable positioner. Each rail has a plurality of apertures formed within the width of the rails. The first and second end of the rails are configured to interlock with each other.

In another embodiment, a first end of the rail has a T-shaped protrusion and a second end has a T-shaped aperture. The T-shaped protrusion is configured to slidably connect within the T- shaped aperture, thereby linking the two adjacent rails. The rails may also have a recess, configured to receive a dog bone shaped connector, between the T-shaped protrusion and T-shaped aperture.

In a further embodiment, a kit for a sawhorse rail system includes the individual rails and sawhorses separately provided for later assembly.

### DRAWINGS

The above, as well as other advantages of the present disclosure, will become readily apparent to those skilled in the art from the following detailed description, particularly when considered in the light of the drawings described hereafter.

FIG.1 is a top perspective view of a series of sawhorses interconnected via a rail system;

FIG. 2 is an exploded top perspective view of the rail system in FIG. 1;

FIG. 3 is an enlarged fragmentary top perspective view taken at callout 3 in FIG. 1, which shows the cooperation of the positioners;

FIG. 4 is an exploded enlarged fragmentary top perspective view taken at callout 5 in FIG. 2, and further illustrating a T-shaped protrusion on one rail that corresponds to a T-shaped aperture on adjacent rail, as well as a dog bone shaped connector;

FIG. 5 is an exploded enlarged fragmentary top perspective view taken at callout 5 in FIG. 2, and further illustrating the T-shaped protrusion on one rail that corresponds to the T-shaped aperture on adjacent rail, as well as the dog bone shaped connector;

FIG. 6 is a partly exploded enlarged fragmentary top perspective view taken at callout 5 in FIG. 2, illustrating the T-shaped protrusion partly engaged with the T-shaped aperture as the rail slides upwards, as well as the dog bone shaped connector;

FIG. 7 is a partly exploded enlarged fragmentary top perspective view taken at callout 5 in FIG. 2, illustrating the T-shaped protrusion fully engaged with the T-shaped aperture, forming a dog bone shaped recess, as well as the dog bone shaped connector; and

FIG. 8 is an enlarged fragmentary top perspective view taken at callout 3 in FIG. 1, illustrating the rail with the T-shaped protrusion fully engaged with the T-shaped aperture, and the dog bone shaped connector disposed in the dog bone shaped recess in the rail system.

### DETAILED DESCRIPTION

The following description is merely exemplary in nature and is not intended to limit the present disclosure, application, or uses. It should also be understood that throughout the drawings, corresponding reference numerals indicate like or corresponding parts and features. In respect of the methods disclosed, the order of the steps presented is exemplary in nature, and thus, is not necessary or critical.

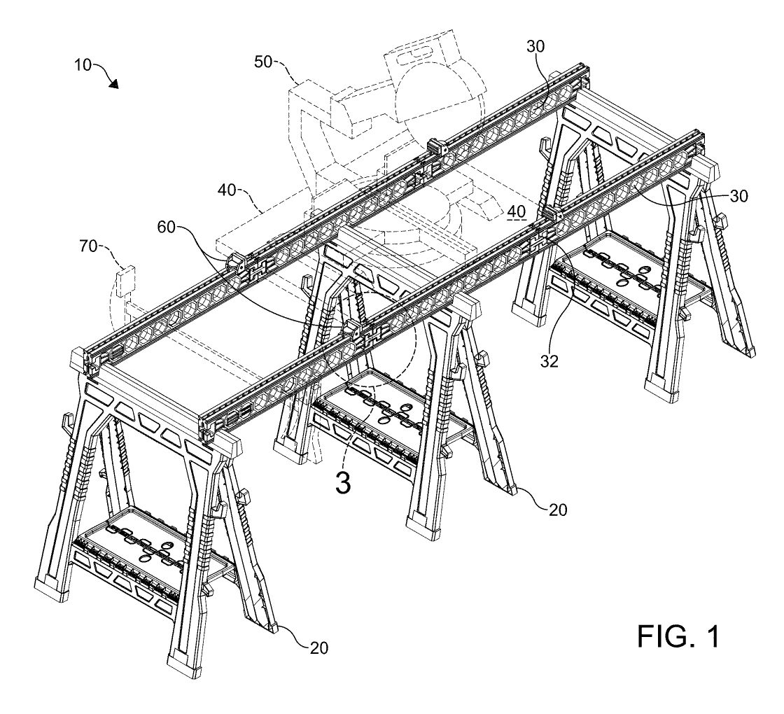

FIGS. 1-8 illustrate a sawhorse rail system 10 according to one embodiment of the present disclosure. The sawhorse rail system 10 includes a plurality of sawhorses 20, and a plurality of rails 30. The plurality of rails 30 cooperate with the sawhorses 20 to form a workbench to support a member 40 and/or a tool 50. The member 40 can be a workpiece such as a piece of wood, metal, plastic, wall board, pipe, tubing, rebar, or the like configured to be manipulated, or to support or provide a work surface, such as for the tool 50, for example. The tool 50 can be any tool commonly employed for manipulating workpieces such as a drill, saw, or any other suitable tool chosen by a skilled artisan.

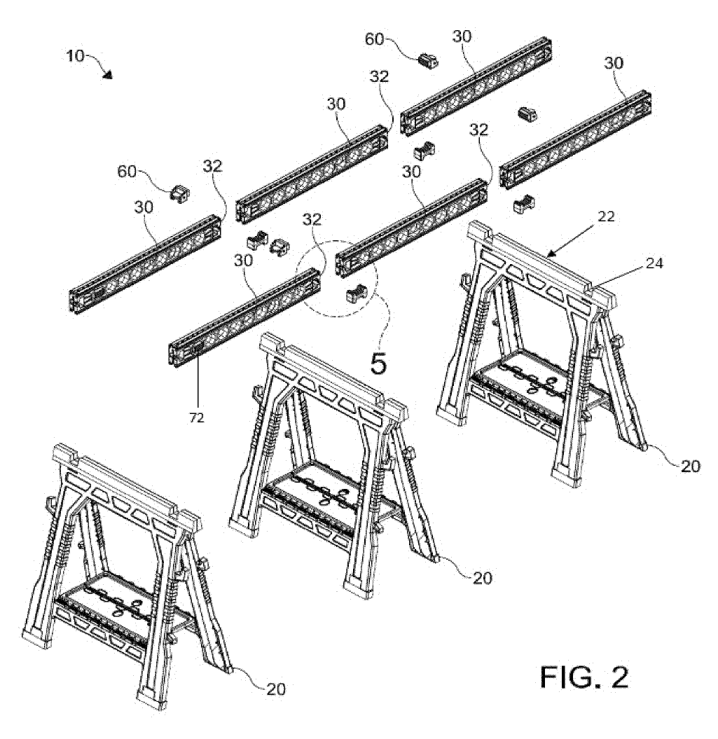

As shown in FIGS. 1-2, each of the sawhorses 20 may include pairs of legs, spaced apart from each other, and extending from a platform 22. The platform includes a pair of spaced apart recesses 24 formed therein. To create a work surface using the sawhorses 20 and rail system, a first pair of the rails 30 is extended between a first sawhorse 20 and a second sawhorse 20, thereby forming substantially parallel supports. The first sawhorse 20 may receive the first pair of rails 30 in the recess 24, for example. The second pair of rails 30 is then connected to the first pair of rails 30 and placed in the recess 24 of the second sawhorse 20.

It should be appreciated that there can be any number of interconnected rails 30 supported by any number of sawhorses 20. Moreover, the sawhorses 20 can be moved along and placed in any position along the length of the rails 30. For example, FIGS. 1-2 illustrate three sawhorses 20 supporting three pairs of interconnected rails 30 forming parallel supports. It should be understood that more than six rails can be employed depending on the number of sawhorses 20. For example, two pairs of rails 30 may be employed to extend between two sawhorses 20.

Additionally, FIGS. 4-8 illustrate how the first pair of rails 30 connect with the second pair of rails 30 at an interface 32. The interface 32 is shown as a sliding connector further stabilized by a dog bone shaped connector 38. Any number of different connectors can also be used, including a quick connect pin, bolts, clamps, or any other connector chosen by a skilled artisan.

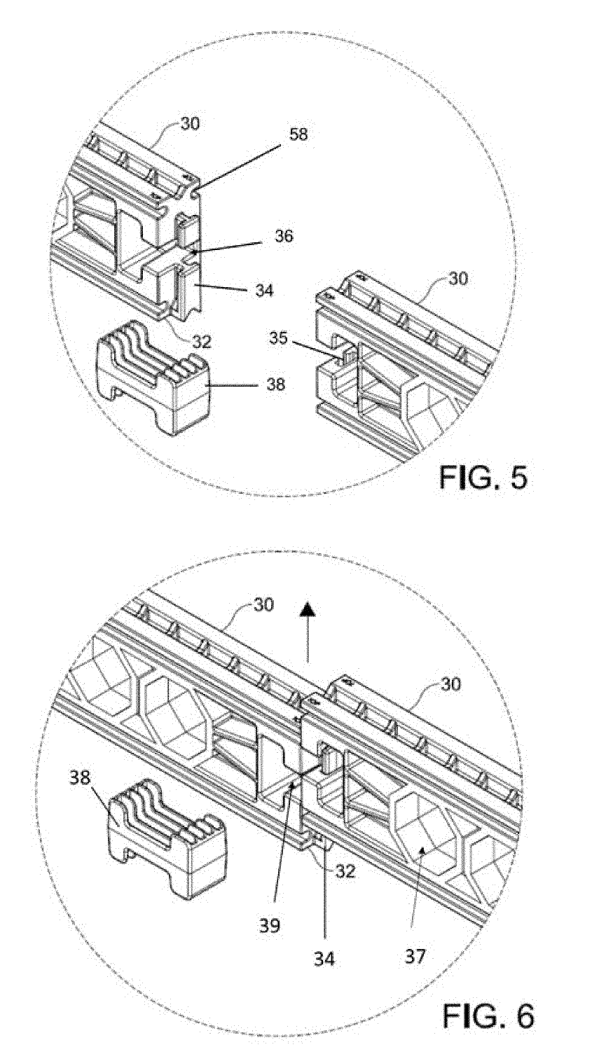

In the embodiment shown, the sliding connector is composed of a T-shaped protrusion 34 on one rail 30 and a T-shaped aperture 35 on an opposing rail 30. The T-shaped protrusion 34 is configured to slide into the T-shaped aperture 35 as shown in FIG. 6.

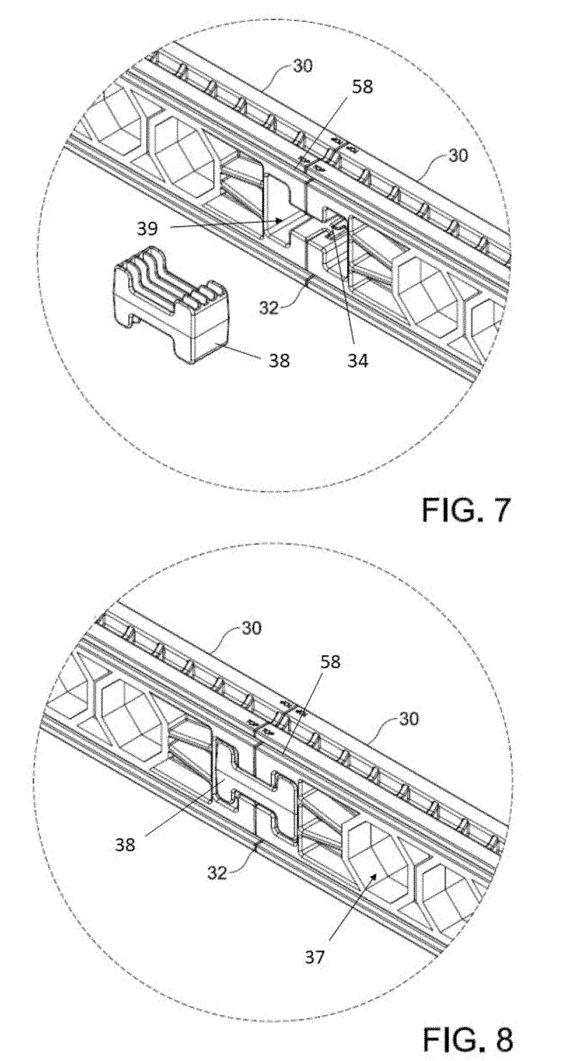

In certain embodiments, the sawhorse rail system 10 will have a recess 39 in the interface 32 to accommodate a dog bone shaped connector 38, which has a pair of opposing T-shape portions. The dog bone shaped connector 38 is inserted into the rail system 10 once the T-shaped protrusion 34 is fully connected with the T-shaped aperture 35, as shown in FIGS. 6-7. Also shown in FIGS. 4-5, the recess 39 continues through the T-shaped protrusion 34 and T-shaped aperture 35 to accommodate the dog bone shaped connector 38. It should be appreciated that although a dog bone shaped connector is shown in the drawings, the rails 30 can be connected using only a T-shaped protrusion 34, and a T-shaped aperture 35.

Furthermore, the interface 32 can also be step shaped (not shown), which facilitates stability of the sawhorse rail system 10. In this embodiment, the steps on each rail are mirror images of the steps on the adjacent rail. Since the steps are each rail are mirror images of each other, the steps form a complimentary surface to create a stable sawhorse system 10.

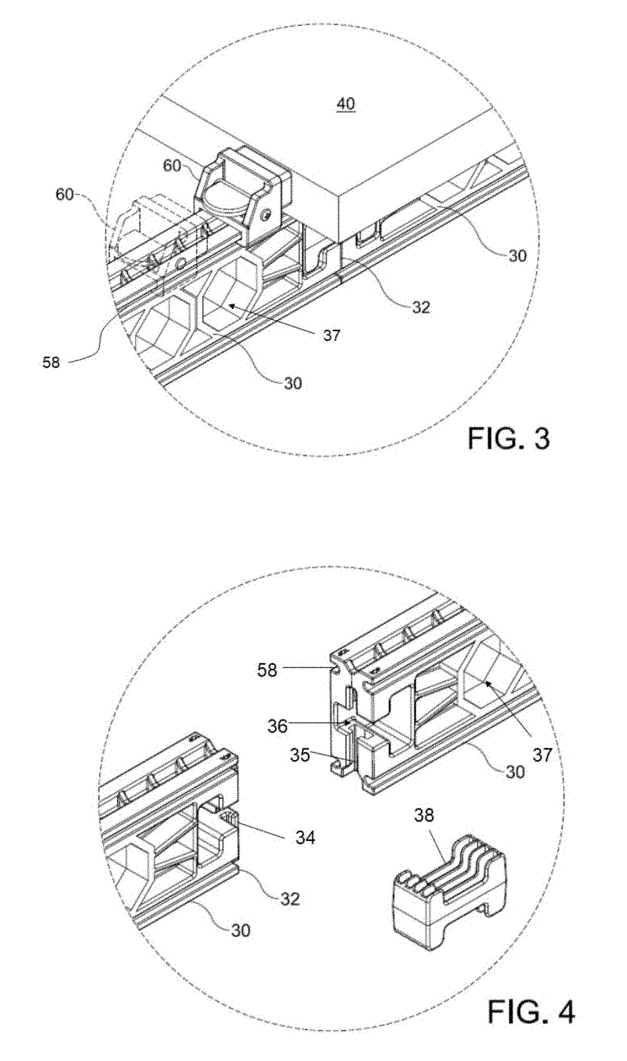

Once the rails 30 are connected, a plurality of positioners 60 can be slidably mounted to the tracks 58 of the rails 30. The tracks 58 are composed of parallel recesses that run the length of the rails 30. In certain embodiments, the positioners 60 are secured to the rail 30 using a latch that initiates a stop cam (not shown), which tightens the positioner 60 to the rail 30 by selectively abutting against the rail 30. As shown in FIG. 3, the positioners 60 are configured to securely position the member 40 for supporting the tool 50 and/or member 40 to be manipulated.

According to one non-limiting example, the member 40 is configured as a workpiece, and may be placed between the positioners 60 to be cut, drilled, or the like. In another non-limiting example, the member 40 can be configured as a support between the positioners 60 to support the tool 50, as illustrated in FIGS. 1 and 3. In yet another example, a workpiece such as a pipe can be inserted through the aligning apertures 37 in the pairs of rails 30 to be cut, drilled, or worked on. Other suitable working configurations for the members 40, the tools 37, and the positions 60 are also contemplated and considered to be within the scope of the present disclosure.

With renewed reference to FIGS. 1-2, additional tools and accessories can also be employed with the sawhorse rail system 10, such as a clamp 70. In certain embodiments, the accessories can be modular work tools 72 configured to fit within the apertures 37 of the rails 30, as shown in FIG. 2. These work tools 72 can include a level, tape measure, pencil, speed square, flashlights, multimeter, sockets, socket swivels, headlamp, container, or any other suitable tool chosen by a skilled artisan. The sawhorse rail system 10 can be adapted and/or employed to support other objects, materials or tools, as desired, or to facilitate woodworking, new construction, remodeling, maintenance, or the like.

Advantageously, the sawhorses 20 and the rails 30 of the present disclosure are easily moved from worksite to worksite, and easily assembled to form a versatile and stable workbench. It should be appreciated that the sawhorse rail system may further be provided in the form of a kit, including individual ones of the sawhorses 20 and the rails 30, for later assembly as described hereinabove.

While certain representative embodiments and details have been shown for purposes of illustrating the invention, it will be apparent to those skilled in the art that various changes may be made without departing from the scope of the disclosure, which is further described in the following appended claims.

What is claimed is:

1. A sawhorse rail system, comprising:
a plurality of adjacent sawhorses; and
a pair of rails removably extending between the plurality of adjacent sawhorses,
wherein each rail has a first end and a second end, the first end of the rail configured to interlock with the second end of the rail.

2. The sawhorse rail system of claim 1, wherein the first end has a T-shaped protrusion and the second end has a T-shaped aperture, the T-shaped protrusion configured to slidably connect with the T- shaped aperture.

3. The sawhorse rail system of claim 1, wherein each sawhorse in the plurality of adjacent sawhorses has a platform, the platform having a pair of recesses configured to support the pair of rails.

4. A sawhorse rail system of claim 1, wherein the first end of the rail is configured to connect to the second end of the rail using a dog bone shaped connector.

5. The sawhorse rail system of claim 1, wherein the moveable positioner abuts a member, and the moveable positioner secures the member to form a work surface.

6. The sawhorse rail system of claim 1, wherein the apertures are circular, hexagonal, square or trapezoid in shape.

7. The sawhorse rail system of claim 1, wherein a variety of work tools are configured to fit in the apertures.

8. The sawhorse rail system of claim 1, wherein each rail has a track that is configured to connect with a moveable positioner.

9. The sawhorse rail system of claim 1, wherein each rail has a plurality of apertures formed spaced apart along a length of the rail.

10. A rail system, comprising:
a first rail and a second rail, the first rail having a T-shaped protrusion and the second rail having a T-shaped aperture, the T-shaped protrusion slidably disposed within the T- shaped aperture.

11. The rail system of claim 10, wherein the first rail and the second rail are configured to connect using a dog bone shaped connecter.

12. The rail system of claim 10, wherein the first rail and the second rail have a track that is configured to connect with a moveable positioner.

13. The rail system of claim 12, wherein a plurality of the moveable positioner abuts a body disposed on the rails, and the plurality of moveable positioners securing the body.

14. The rail system of claim 10, wherein each rail has a plurality of apertures formed within the width of the rails.

15. The rail system of claim 14, wherein a variety of work tools are configured to fit within the apertures formed within the width of the rails.

16. The rail system of claim 14, wherein the apertures are circular, hexagonal, square or trapezoid in shape.

17. A kit for a sawhorse rail system, comprising:
a first rail and a second rail, the first rail having a T-shaped protrusion and the second rail having a T-shaped aperture, the T-shaped protrusion slidably disposed within the T- shaped aperture.

18. The kit of claim 17, further comprising a plurality of adjacent sawhorses.

19. The kit of claim 17, wherein the first rail has a T-shaped aperture on an end opposite the T-shaped protrusion, and the second rail has a T-shaped protrusion on an end opposite the T-shaped aperture.

20. The kit of claim 17, wherein each rail has a first end and a second end, the first end of the rail configured to interlock with the second end of the rail.
